(19) United States
(12) Patent Application Publication
(10) Pub. No.: US 2021/0368749 A1
(43) Pub. Date: Dec. 2, 2021

(54) TEST DEVICE FOR NONINVASIVE TESTING OF FISH HABITAT SELECTION AND APPLICATION THEREOF

(71) Applicant: Institute of Hydrobiology, Chinese Academy of Sciences, Wuhan City (CN)

(72) Inventors: Ming DUAN, Wuhan City (CN); Weiwei LI, Wuhan City (CN); Jianghui BAO, Wuhan City (CN); Chaoshuo ZHANG, Wuhan City (CN); Xiangyuan MI, Wuhan City (CN); Dongxu ZHANG, Wuhan City (CN)

(21) Appl. No.: 17/215,237

(22) Filed: Mar. 29, 2021

(30) Foreign Application Priority Data
May 29, 2020 (CN) 202010479504.1

(51) Int. Cl. A01K 63/02; A01K 63/04

(52) U.S. Cl. CPC A01K 63/02; A01K 63/047

(57) ABSTRACT

A test device for noninvasive testing of fish habitat selection and application thereof is described herein. The device includes a camera device, a water circulating system, a fish transporting barrel, and a test water tank. The fish transporting barrel is a water barrel with an openable bottom. The central area of the test water tank is arranged as a closed adaptation area, a water outlet is formed in the bottom of the adaptation area. Fish passages are formed in the adaptation area. Test areas with equal sizes are formed around the adaptation area through partition plates. A water inlet is formed in each test area. Water flow buffering plates are arranged corresponding to the water inlets. Fish passages are formed in the bottoms of the partition plates of the test areas. The water inlets of the test areas are connected to the water circulating system.

### TECHNICAL FIELD

The present disclosure relates to the field of fish ethology, and in particular, to a test device for nondestructive testing of fish habitat selection and application thereof.

### BACKGROUND

Fish ethology is a discipline that researches interactions of fish with environment and other organisms, which has important guiding significance for fish resource protection and fishery aquaculture production. Fish preference behaviors are effective indexes for measuring the selection and preference degree of fish for different threshold values of environmental factors, and are important contents in the researches of protection of fish natural habitats, designs of fish passing facilities, welfare aquaculture, and the like. The environmental factors, such as the light and the substrate, are conventional contents in the researches of fish behavior preference. The researches of fish preference behaviors are achieved on the basis of the distribution frequency of fish in various different environmental factors. Therefore, how to effectively eliminate human interference and the interference of other environmental factors with target factors of a test is the key to the success or failure of preference behavior research in the test.

The researches of light and substrate preference behaviors usually adopt a still water test method, or are performed in a loop similar to flow velocity selection. By adopting the still water test method, due to the lack of induction of a swimming behavior, fish are likely to stay in the same place without moving or swim without swimming beyond the boundaries of environmental factors, so that the preference behaviors cannot be truly reflected, thereby resulting in test errors or wrong conclusions. By adopting a loop test method, a flow velocity gradient distribution mode with uniform transverse flow velocity and different longitudinal flow velocity may be formed, so the behavior interference will be produced on because of flow control instinct of the fish during testing, resulting in that the test results are not convincing. In addition, the fluctuation of a water surface may be caused in most flow tests, which leads to image interference when refined analysis is performed on behaviors by using software in the later stage.

However, in the existing researches, researchers mostly consider the interference factors inside the test areas, but ignore the influence of human factors on test objects. Before and after the test, the fish are often subjected to human stress during transporting, which leads to test errors or wrong conclusions.

### SUMMARY

An objective of the present disclosure is to provide a test device for noninvasive testing of fish habitat selection. The device of the present disclosure can realize a research on fish preference for multiple environmental factors, such as light and substrate, eliminate the influence on the preference behavior research results caused by non-directional swimming and water flow overcoming of fish, and eliminate the influence of stress response of fish caused by human manipulation on the preference behavior research results.

Another objective of the present disclosure is to provide application of a test device for noninvasive testing of fish habitat selection.

To achieve the above objectives, the technical solutions adopted by the present disclosure are that:

A test device for noninvasive testing of fish preference includes a camera device, a water circulating system, a fish transporting barrel, and a test water tank.

The fish transporting barrel is a water barrel with an openable bottom, and the bottom of the fish transporting barrel is connected to a traction device.

The test water tank is a container with an opening in top, and the central area of the test water tank is arranged as a closed adaptation area through partition plates. The diameter of the adaptation area is slightly greater than that of the fish transporting barrel. A water outlet is formed in the bottom of the adaptation area. Fish passages are formed in the positions, close to the bottom of the partition plate, of the adaptation area. Test areas with equal sizes are formed around the adaptation area through partition plates. A water inlet is formed in the wall of the water tank where each test area is located. Water flow buffering plates are arranged corresponding to the water inlets. Fish passages are formed in the bottoms of the partition plates of the test areas.

The water inlets of the test areas are connected to inlet water of the water circulating system after being connected in parallel through water pipes; the other end of the water circulating system is connected to the water outlet.

The camera device is arranged at the upper part of the test water tank.

The water circulating system includes a filtering system and a circulating pump.

In the test device described above, preferably, the traction device is a pull rope or a pull rod.

The test device described above, preferably, further includes a retractable grille.

In the test device described above, preferably, the camera device is an infrared camera device.

In the test device described above, preferably, substrate layers are laid at the bottoms of the test areas.

In the test device described above, preferably, light sources are arranged in the test areas.

In the test device described above, preferably, the partition plates are light tight partition plates.

In the test device described above, preferably, a handle is arranged on the fish transporting barrel.

Application of a test device for noninvasive testing of fish preference, includes performing the detection of light preference, substrate preference, or the influence of water flow velocity on fish by using the device.

In the application described above, when the light and substrate preference of the fish are detected, the process of the application includes the following steps:

(1) filling the test water tank with water, regulating the water flow through the water circulating system, arranging the camera device above the test water tank, and placing the fish transporting barrel in the adaptation area;

(2) placing light strips or distributing substrates in the test areas as required, so that the test areas form different light characteristics or different substrate types; before the test, placing the fish into the fish transporting barrel to adapt for a period of time, and then placing the fish transporting barrel in the adaptation area of the test water tank to continue adapting for a period time; opening the bottom of the fish transporting barrel through the traction device, and slowly lifting out the fish transporting barrel; starting testing;

(3) at the end of the test, driving the fish back into the adaptation area by using the grille, blocking an exit by using the grille, placing the fish transporting barrel in the adaptation area slowly, opening the bottom of the fish transporting barrel, and lifting the test fish out of the adaptation area;

(4) analyzing the preference of the test fish for environmental light color and substrate through the data recorded by the camera; recording the occurrence frequency of the test fish in each area every other several minutes and the total occurrence frequency of the test fish in all test areas in the whole test period, where, the preference is represented by the percentage of the occurrence number in each area.

P=(n/N)*100%

where P is the percentage of the occurrence number in each area, n is the occurrence frequency of the test fish in each area, and N is the total occurrence frequency of the test fish in all test areas in the whole test period.

Compared with the prior art, the present disclosure has the following beneficial effects:

1. The device can realize a research on fish preference for multiple environmental factors, such as light and substrate, according to different environmental factors arranged in the test areas.

2. According to the device, the water flow buffering plates are added to the water inlets, which eliminates the influence on the preference behavior research results caused by non-directional swimming and water flow overcoming of the fish, eliminates the fluctuation of a water surface, and is beneficial to video observation and analysis.

3. The device eliminates the influence of the stress caused by human manipulation on the preference behavior research results.

4. The tests of various environmental factors can be implemented in the same device, which can ensure the consistency of research environments, eliminate the interference of other environmental factors in the behavior preference research, and is beneficial to comparison and repetition of test data.

5. Night behavior observation can be realized by recording the fish behaviors by adopting infrared videos.

### BRIEF DESCRIPTION OF THE DRAWINGS

FIG. 1 is a schematic structural diagram of a test device for noninvasive testing of fish preference in Embodiment 1 of the present disclosure;

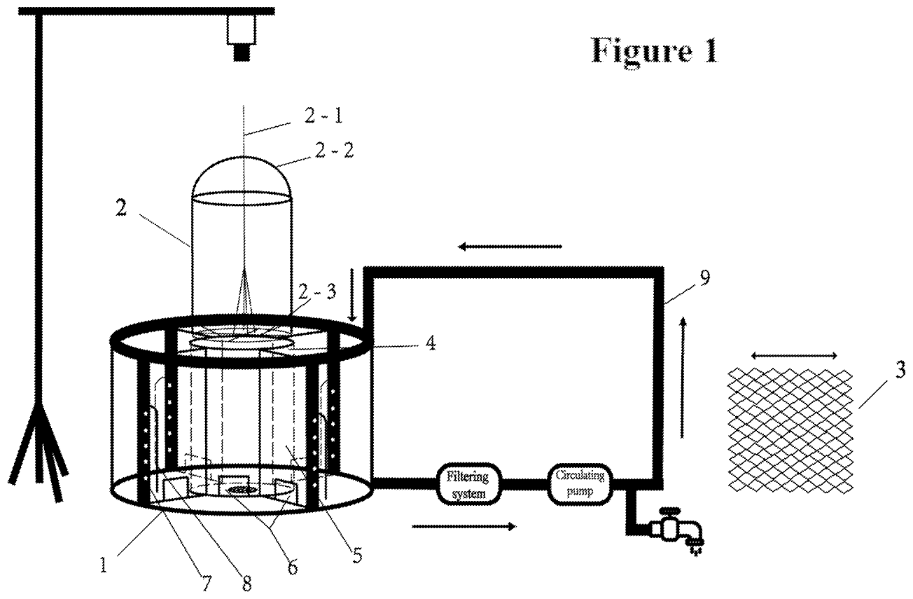

FIG. 2 is a vertical view of the test device for noninvasive testing of fish preference in Embodiment 1 of the present disclosure.

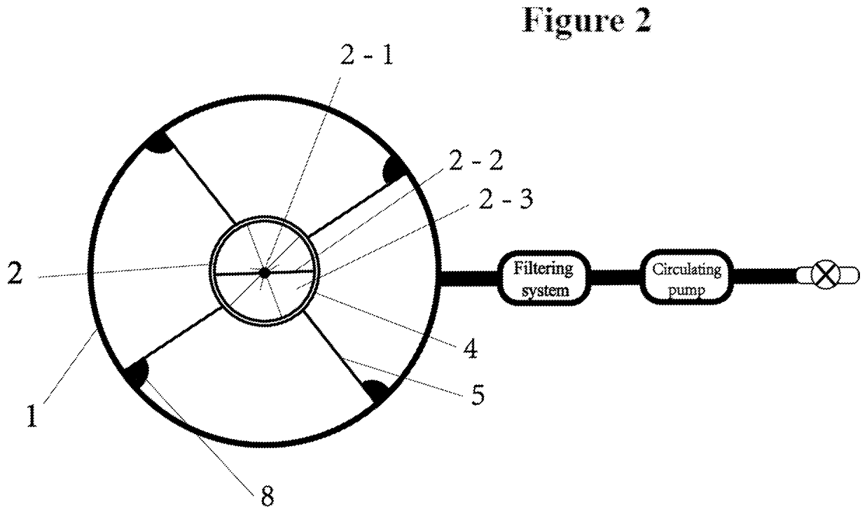

In the drawings: 1—test water tank, 2—fish transporting barrel; 2-1—pull rope; 2-2—handle; 2-3—bottom of water barrel; 3—retractable grille; 4—adaptation area; 5—partition plate; 6—fish passage; 7—water inlet; 8—water flow buffering plate; 9—water circulating system; arrow-water flow direction.

### DETAILED DESCRIPTION

The technical solutions of the present disclosure, if not specified, are all conventional solutions in the art; the reagents or materials, if not specified, are from commercial channels.

### Embodiment 1

A test device for noninvasive testing of fish preference includes a camera device, a water circulating system 9, a fish transporting barrel 2, a test water tank 1, and a retractable grille 3.

The fish transporting barrel 2 is a cylindrical water barrel with an openable bottom. The bottom of the water barrel is evenly divided into four parts by passing through the center of the circle. The periphery of the bottom is movably linked with the bottom of the wall of the water barrel. Pull ropes 2-1 are arranged bottom 2-3 which is divided into four parts. A handle 2-2 is arranged on the fish transporting barrel.

The test water tank 1 is a round container with an opening in top. The central area of the round container is arranged as a closed circular adaptation area 4 through partition plates. The diameter of the adaptation area 4 is slightly greater than that of the fish transporting barrel 2. A water outlet is formed in the bottom of the adaptation area. Fish passages 6 are formed in the positions, close to the bottoms of the partition plates, of the adaptation area. Test areas with equal sizes are formed around the adaptation area through partition plates 5. A water inlet 7 is formed in the wall of the water tank where each test area is located. Water flow buffering plates 8 are arranged corresponding to the water inlets. Fish passages 6 are formed in the bottoms of the partition plates 5 of the test areas.

The water inlets 7 of the test areas are connected to inlet water of a water circulating system 9 after being connected in parallel through water pipes. The other end of the water circulating system is connected to a water outlet.

The camera device is arranged at the upper part of the test water tank 1. The camera device is an infrared camera device.

The water circulating system 9 includes a filtering system (Sensen CPA 5000) and a circulating pump (WTP horizontal high-efficiency energy-saving special circulating pump 40-125-1.1).

The partition plates are light tight partition plates.

### Embodiment 2

Application of a test device for noninvasive testing of fish preference in light preference test of schizothoracids:

1. The test water tank in the device of Embodiment 1 was filled with water, the water inlet amount and the water outlet amount were regulated through the water circulating system, different colors of light strips (white light, green light, red light, and blue light) were arranged in the test areas, and the light intensity was regulated (white light: 62.22±14.98 lx, green light: 62.11±10.87 lx, red light: 51.11±12.15 lx, blue light: 63.55±25.97 lx) to create required environments.

2. Fish preference test: one test fish was placed into the fish transporting barrel to adapt for 30 minutes, and the fish transporting barrel was placed into the adaptation area of the test water tank to continue adapting for 30 minutes. The bottom of the fish transporting barrel was opened through the pull ropes; the fish transporting barrel was lifted out slowly; the test was started.

The distribution positions of the fish was observed by using the infrared camera. The distribution positions of the fish were recorded for 24 hours continuously. The number of the fish in each test area was recorded every other 5 minutes.

3. Test data acquisition and preference index calculation: the percentages of the occurrence frequency of the schizothoracids in white light, green light, red light, and blue light were calculated through video playback by using a formula:

P=(n/N)*100%

where P is the percentage of the occurrence number in each area, n is the occurrence frequency of the test fish in each area, and N is the total occurrence frequency of the test fish in all test areas in the whole test period.

4. Maintenance and cleaning of the device: after the end of the test, the test device and supporting systems were detached, cleaned and maintained, and then, were stored in categories.

In the test, the research on light preference is carried out by taking the schizothoracids with an average body length of 20 cm as an object, and the light is set as white light, green light, red light, and blue light. The test of each fish is recorded for 24 hours, and six groups are repeated. The test results are as follows, and finally, the percentages of the occurrence frequency of the schizothoracids with this specification in white light, green light, red light, and blue light are respectively: 37.2%, 19.7%, 13.2%, and 29.9%. The results show that the schizothoracids prefers white light and blue light, and does not obviously prefers red light and green light. Researches have shown that blue light can relieve the pressure of Oreochromis niloticus and increase its reproductive capacity (Maia & Volpato, 2017), and Micropterus salmoides repels red light (Brittany et al., 2016). The occurrence frequency is used for statistics in relevant researches, but the tests of the relevant researches are carried out in still water, which ignores the influence of non-directional swimming of fish on the test. Rectangular test equipment without an adaptation area is adopted in the test of the Micropterus salmoides, and errors of test statistics are ignored. The schizothoracids lives at the bottom of a water body. Spectral colors are filtered step by step after sunlight passes through the water body. Most light on the surface of the water body is red light, and most light at the bottom of the water body is blue light (Bowmaker, 1995). So, the preference of the schizothoracids for blue light is consistent with the fact. The preference for white light may be because white light is composite light, so fish also develop a preference for it.

| | White | Green | Red | Blue |
|---|---|---|---|---|
| Number of test fish | light (%) | light (%) | light (%) | light (%) |
| 1 | 37.3 | 36.7 | 10.8 | 15.2 |
| 2 | 71.7 | 13.0 | 5.1 | 10.5 |
| 3 | 40.3 | 20.7 | 13.5 | 25.5 |
| 4 | 15.9 | 16.7 | 18.6 | 48.8 |
| 5 | 37.6 | 24.2 | 19.8 | 18.4 |
| 6 | 20.4 | 6.9 | 11.6 | 61.1 |
| Total | 37.2 | 19.7 | 13.2 | 29.9 |

### Embodiment 3

Application of a test device for noninvasive testing of fish preference in substrate preference test of schizothoracids:

1. The test water tank in the device of Embodiment 1 was filled with water, the water inlet amount and the water outlet amount were regulated through the water circulating system, and different substrates (cement pool bottom, crushed gravel, pebbles, and cobbles) were arranged in the test areas to create required environments.

2. Fish preference test: one test fish was placed into the fish transporting barrel to adapt for 30 minutes, and the fish transporting barrel was placed into the adaptation area of the test water tank to continue adapting for 30 minutes. The bottom of the fish transporting barrel was opened through the pull ropes; the fish transporting barrel was lifted out slowly; the test was started.

The distribution positions of the fish were observed and recorded by using the infrared camera. The distribution positions of the fish were recorded for 24 hours continuously. The number of the fish in each test areas was recorded every other 5 minutes.

3. Test data acquisition and preference index calculation: the percentages of the occurrence frequency of the schizothoracids in the test areas with the cement pool bottom, the crushed gravel, the pebbles, and the cobbles were calculated through video playback by using a formula:

P=(n/N)*100%

4. Maintenance and cleaning of the device: after the end of the test, the test device and supporting systems were detached, cleaned and maintained, and then, were stored in categories.

In the test, the substrate preference research is carried out by taking the schizothoracids with an average body length of 20 cm as an object, and the substrate is arranged as the habitats with the cement pool bottom, the crushed gravel, the pebbles, and the cobbles. The test of each fish is recorded for 24 hours, and six groups are repeated. The test results are as follows, and the percentages of the occurrence frequency of the schizothoracids in the habitat areas with the substrates arranged as the cement pool bottom, the crushed gravel, the pebbles, and the cobbles are respectively: 31.0%, 38.9%, 6.0% and 24.1%. The results show that the schizothoracids prefers the crushed gravel. The schizothoracids usually lives in a small slow flowing bay in a river, usually feeds in a riverbed with the substrate of sand and gravel, and spawns in a fast flowing gravel river in reproduction period. The operation period of the test is July and August, and the obtained preference of the schizothoracids for the crushed gravel is consistent with the fact.

| Number of test fish | Cement pool | Crushed | | |
|---|---|---|---|---|
| (%) | bottom(%) | gravel (%) | Pebbles(%) | Cobbles |
| 1 | 2.8 | 51.4 | 6.9 | 38.9 |
| 2 | 23.6 | 50.0 | 6.9 | 19.5 |
| 3 | 65.3 | 19.4 | 4.2 | 11.1 |
| 4 | 40.3 | 37.5 | 6.9 | 15.3 |
| 5 | 38.9 | 38.9 | 5.6 | 16.6 |
| 6 | 15.3 | 36.1 | 5.6 | 43.0 |
| Total | 31.0 | 38.9 | 6.0 | 24.1 |

The descriptions above are merely non-limited embodiments of the present disclosure. A number of variations and modifications may be made by those of ordinary skill in the art without departing from the conception of the present disclosure or making creative effort, and all fall within the scope of protection of the present disclosure.

What is claimed:

1. A test device for noninvasive testing of fish preference, comprising:
a camera device;
a water circulating system;
a fish transporting barrel; and
a test water tank;
wherein:
the fish transporting barrel is a water barrel with an openable bottom, the bottom of the fish transporting barrel is connected to a traction device, the test water tank is a container with an opening in top, and the central area of the test water tank is arranged as a closed adaptation area through partition plates;
a diameter of the adaptation area is greater than a diameter of the fish transporting barrel;
a water outlet is formed in the bottom of the adaptation area;
fish passages are formed in positions, close to the bottom of the partition plate, of the adaptation area;
test areas with equal sizes are formed around the adaptation area through partition plates;
a water inlet is formed in a wall of the water tank where each test area is located;
water flow buffering plates are arranged corresponding to the water inlets;
fish passages are formed in the bottoms of the partition plates of the test areas;
the water inlets of the test areas are connected to inlet water of the water circulating system after being connected in parallel through water pipes;
another end of the water circulating system is connected to a water outlet;
the camera device is arranged at an upper part of the test water tank; and
the water circulating system comprises a filtering system and a circulating pump.

2. The test device of claim 1, wherein the traction device is a pull rope or a pull rod.

3. The test device of claim 1, further comprising a retractable grille.

4. The test device of claim 1, wherein the camera device is an infrared camera device.

5. The test device of claim 1, wherein the partition plates are light tight partition plates.

6. The test device of claim 1, wherein a handle is arranged on the fish transporting barrel.

7. The device of claim 1, wherein substrate layers are paved at the bottoms of the test areas.

8. The test device of claim 1, wherein light sources are arranged in the test areas.

9. A method for noninvasive testing of fish preference in detection of light preference, substrate preference, or the influence of water flow velocity of fish utilizing the test device of claim 1, the method comprising:
filling the test water tank with water;
providing one or more fish in the water tank; and
observing and recording positions of the one or more fish in the water tank utilizing the camera device.
